(19) United States
(12) Patent Application Publication
(10) Pub. No.: US 2025/0295261 A1
(43) Pub. Date: Sep. 25, 2025

(54) SOUS VIDE ASSEMBLY FOR USE IN A MICROWAVE OVEN

(71) Applicant: Haier US Appliance Solutions, Inc., Wilmington, DE (US)

(72) Inventors: Blake Ellis, Louisville, KY (US); Bagawathkumar Chellappan, Prospect, KY (US); Mark Heimerdinger, Louisville, KY (US)

(21) Appl. No.: 18/613,909

(22) Filed: Mar. 22, 2024

(51) Int. Cl. A47J 27/10; A47J 27/00

(52) U.S. Cl. CPC A47J 27/10; A47J 27/002

(57) ABSTRACT

A sous vide assembly for use in a microwave oven includes a sous vide container defining a water reservoir, a food insert positioned inside the water reservoir and defining one or more food cavities, wherein an outer wall of the food insert defines a plurality of recessed grooves that separate the one or more food cavities from the sous vide container, and a lid assembly mounted to a top of the sous vide container, the lid assembly defining one or more vent holes and being removable to provide selective access to the one or more food cavities.

### FIELD OF THE INVENTION

The present subject matter relates generally to microwave oven appliances, and more particularly to systems and methods for implementing sous vide cooking in microwave oven appliances.

### BACKGROUND OF THE INVENTION

Microwave oven appliances generally include a cabinet that defines a cooking chamber for receipt of food items for cooking. These appliances typically include one or more heating elements for generating energy to heat the food items during a cooking process. For example, microwave ovens typically include at least one source of electromagnetic radiation in the microwave frequency range, such as a cavity magnetron. In order to provide selective access to the cooking chamber and to contain food particles and cooking energy (e.g., microwaves) during a cooking operation, microwave appliances further include a door that is typically pivotally mounted to the cabinet.

Sous vide is a method of cooking that requires the application of low levels of heat (e.g., 130 to 160 degrees Fahrenheit) over the course of several hours (e.g., one or more hours, such as two or more hours, such as three or more hours, etc.). In sous vide, food is often cooked by sealing the food a liquid-proof bag and submerging the bag in liquid that is maintained at the desired temperature. However, conventional sous vide assemblies and cooking methods for use in a microwave permit direct exposure of the food to microwave energy, which may quickly result in overcooking or uneven heating. In addition, conventional sous vide assemblies may heat the cooking liquid inefficiently, resulting in extended cooking times. Conventional sous vide assemblies may also be ineffective at properly positioning and securing food items within the heated water.

Accordingly, a microwave oven and sous vide assembly that facilitates improved sous vide cooking would be desirable. More specifically, a sous vide assembly that may be used in a microwave to facilitate a sous vide cooking process while preventing the exposure of food to undesirable levels of microwave energy would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a sous vide assembly for use in a microwave oven is provided. The microwave oven includes a cabinet defining a cooking chamber. The sous vide assembly includes a sous vide container defining a water reservoir, a food insert positioned inside the water reservoir and defining one or more food cavities, wherein an outer wall of the food insert defines a plurality of recessed grooves that separate the one or more food cavities from the sous vide container, and a lid assembly mounted to a top of the sous vide container, the lid assembly being removable or pivotable to provide selective access to the one or more food cavities.

In another exemplary embodiment, a microwave oven defining a vertical, a lateral, and a transverse direction is provided. The microwave oven includes a cabinet defining a cooking chamber, a door rotatably mounted to the cabinet for providing selective access to the cooking chamber, and a sous vide assembly configured for receipt within the cooking chamber. The sous vide assembly includes a sous vide container defining a water reservoir, a food insert positioned inside the water reservoir and defining one or more food cavities, wherein an outer wall of the food insert defines a plurality of recessed grooves that separate the one or more food cavities from the sous vide container, and a lid assembly mounted to a top of the sous vide container, the lid assembly defining one or more vent holes and being removable to provide selective access to the one or more food cavities.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective front view of a microwave oven appliance in accordance with an example embodiment of the present disclosure.

FIG. 2 provides a perspective view of the exemplary microwave oven of FIG. 1 with the door in an open position according to exemplary embodiments of the present disclosure.

FIG. 3 provides a perspective view of a sous vide assembly that may be used in the exemplary microwave oven of FIG. 1 according to an exemplary embodiment of the present subject matter.

FIG. 4 provides a side view of the exemplary sous vide assembly of FIG. 3 according to an exemplary embodiment of the present subject matter.

FIG. 5 provides a front view of the exemplary sous vide assembly of FIG. 3 according to an exemplary embodiment of the present subject matter.

FIG. 6 provides a top view of a sous vide container of the exemplary sous vide assembly of FIG. 3 according to an exemplary embodiment of the present subject matter.

FIG. 7 provides a bottom view of a food insert of the exemplary sous vide assembly of FIG. 3 according to an exemplary embodiment of the present subject matter.

FIG. 8 provides a perspective view of a lid container of the exemplary sous vide assembly of FIG. 3 according to an exemplary embodiment of the present subject matter.

FIG. 9 provides a bottom view of a lid cap of the exemplary sous vide assembly of FIG. 3 according to an exemplary embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

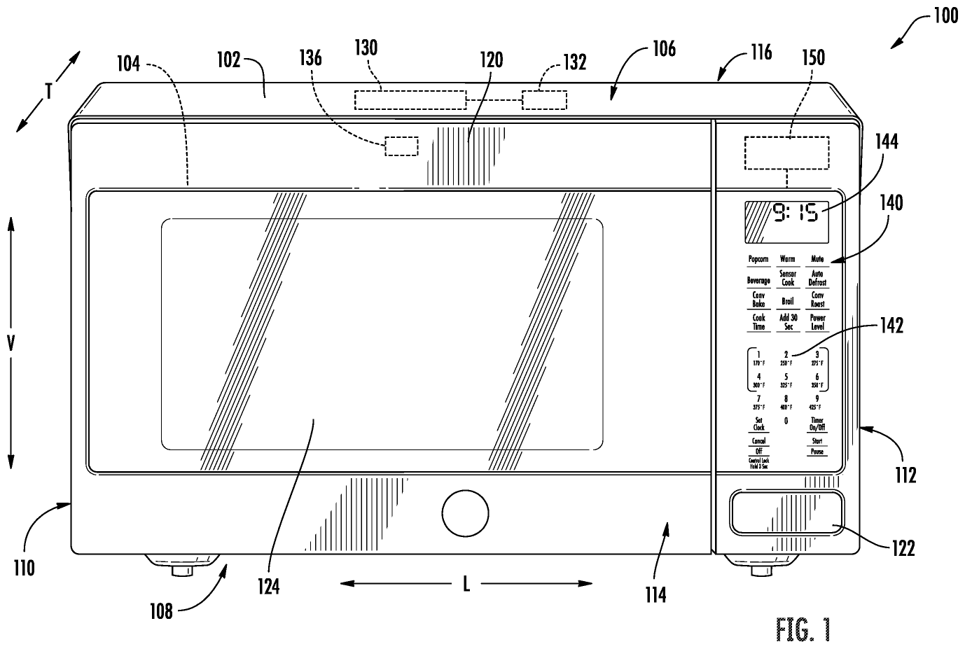

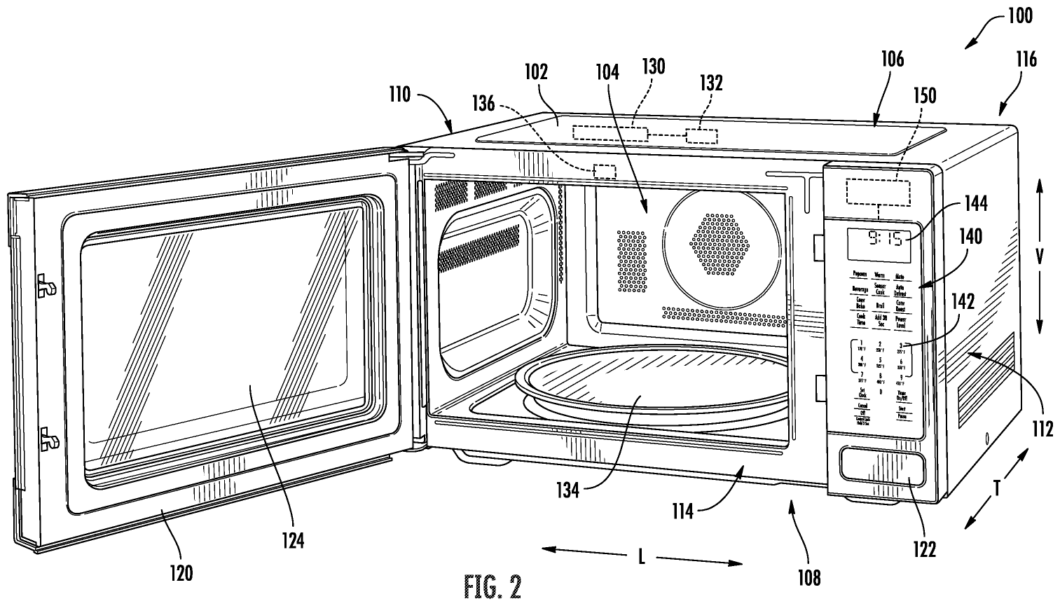

Referring now to the figures, FIG. 1 provides a front view of a microwave oven 100 as may be employed with the present subject matter and FIG. 2 provides a perspective view of microwave oven 100 with the door in the open position. Microwave oven 100 includes an insulated cabinet 102 that defines a cooking chamber 104 for receipt of food items for cooking. As will be understood by those skilled in the art, microwave oven 100 is provided by way of example only, and the present subject matter may be used in any suitable microwave oven, such as a countertop microwave oven, an over-the-range microwave oven, etc. Thus, the example embodiment shown in the figures is not intended to limit the present subject matter to any particular cooking chamber configuration or arrangement.

As illustrated, microwave oven 100 generally defines a vertical direction V, a lateral direction L, and a transverse direction T, each of which is mutually perpendicular, such that an orthogonal coordinate system is generally defined. Cabinet 102 of microwave oven 100 extends between a top 106 and a bottom 108 along the vertical direction V, between a first side 110 (left side when viewed from front) and a second side 112 (right side when viewed from front) along the lateral direction L, and between a front 114 and a rear 116 along the transverse direction T.

Microwave oven 100 includes a door 120 that is rotatably attached to cabinet 102 in order to permit selective access to cooking chamber 104. A handle may be mounted to door 120 to assist a user with opening and closing door 120 in order to access cooking chamber 104. As an example, a user can pull on the handle mounted to door 120 to open or close door 120 and access cooking chamber 104. Alternatively, microwave oven 100 may include a door release button 122 that disengages or otherwise pushes open door 120 when depressed. Glass windowpanes 124 provide for viewing the contents of cooking chamber 104 when door 120 is closed and also assist with insulating cooking chamber 104.

Microwave oven 100 is generally configured to heat articles, e.g., food or beverages, within cooking chamber 104 using electromagnetic radiation. Microwave appliance 100 may include various components which operate to produce the electromagnetic radiation, as is generally understood. For example, microwave appliance 100 may include a microwave heating assembly 130 which may include a magnetron (such as, for example, a cavity magnetron), a high voltage transformer, a high voltage capacitor and a high voltage diode.

According to exemplary embodiments, microwave oven 100 may further include an inverter power supply 132 that is operably coupled to microwave heating assembly 130 to provide energy from a suitable energy source (such as an electrical outlet) to microwave heating assembly 130, e.g., the magnetron. The magnetron may convert the energy to electromagnetic radiation, specifically microwave radiation. Microwave heating assembly 130 and/or inverter power supply 132 may include other suitable components, such as a capacitor that generally connects the magnetron and power supply, such as via high voltage diode, to a chassis. Microwave radiation produced by the magnetron may also be transmitted through a waveguide to cooking chamber 104.

As would be appreciated by one having ordinary skill in the art, inverter power supply 132 allows the magnetron's analog electric field intensity to be adjusted between various power levels, such as between 10% and 100% of the total power capacity. By contrast, with conventional non-inverter power supplies, the electric field intensity is either 100% or 0%, and power levels are made using a timed duty cycle. For example, a non-inverter power supply set for a 50% power level would turn the magnetron ON at 100% output power for 15 seconds, and then OFF for 15 seconds. At power levels less than 100%, inverter power supply 132 has much better heating uniformity and less penetration depth-ideal heating for sous vide as the inverter power supply heats the water while avoiding direct heating of the food with microwave energy.

The structure and intended function of microwave ovens are generally understood by those of ordinary skill in the art and are not described in further detail herein. According to alternative embodiments, microwave oven may include one or more heating elements, such as electric resistance heating elements, gas burners, other microwave heating elements, halogen heating elements, or suitable combinations thereof, are positioned within cooking chamber 104 for heating cooking chamber 104 and food items positioned therein.

Microwave oven 100 may include additional features to improve heating uniformity and precision. For example, according to an exemplary embodiment, microwave oven 100 includes a turntable 134 rotatably mounted within cooking chamber 104. Turntable 134 may be selectively rotated during a cooking process to ensure improved temperature uniformity for the object being heated. In addition, microwave oven 100 may include an infrared temperature sensing array 136 that can measure temperatures across the entire bottom of the cooking chamber 104. Temperature sensing array 136 may detect temperatures at various distinct temperature locations, may associate certain locations with the food items being cooked, and may use a subset of the temperature data as feedback for regulating inverter power supply 128 and microwave heating assembly 126 for improved precision. For example, temperature sensing array 136 may include one or more infrared sensors mounted to a top of cooking chamber 104 for periodically or continuously monitoring a surface temperature of the water in a sous vide assembly.

Referring again to FIG. 1, a user interface panel 140 and a user input device 142 may be positioned on an exterior of the cabinet 102. The user interface panel 140 may represent a general purpose Input/Output (“GPIO”) device or functional block. In some embodiments, the user interface panel 140 may include or be in operative communication with user input device 142, such as one or more of a variety of digital, analog, electrical, mechanical or electro-mechanical input devices including rotary dials, control knobs, push buttons, and touch pads. The user input device 142 is generally positioned proximate to the user interface panel 140, and in some embodiments, the user input device 142 may be positioned on the user interface panel 140. The user interface panel 140 may include a display component 144, such as a digital or analog display device designed to provide operational feedback to a user.

Generally, microwave oven 100 may include a controller 150 in operative communication with the user input device 142. The user interface panel 140 of the microwave oven 100 may be in communication with the controller 150 via, for example, one or more signal lines or shared communication busses, and signals generated in controller 150 operate microwave oven 100 in response to user input via the user input devices 142. Input/Output (“I/O”) signals may be routed between controller 150 and various operational components of microwave oven 100. Operation of microwave oven 100 can be regulated by the controller 150 that is operatively coupled to the user interface panel 140.

Controller 150 is a “processing device” or “controller” and may be embodied as described herein. Controller 150 may include a memory and one or more microprocessors, microcontrollers, application-specific integrated circuits (ASICS), CPUs or the like, such as general or special purpose microprocessors operable to execute programming instructions or micro-control code associated with operation of microwave oven 100, and controller 150 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, a controller 150 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Aspects of the present subject matter are generally directed to systems and methods for implementing a sous vide cooking process in a microwave oven, such as microwave oven 100. More particularly, according to exemplary embodiments of the present subject matter, cooking chamber 104 is configured for receipt of a sous vide assembly 200 (e.g., on turntable 134) for facilitating a sous vide cooking process within microwave oven 100. According to exemplary embodiments, turntable 134 is rotated during the sous vide process for improved thermal uniformity. As would be appreciated by one having ordinary skill in the art, a sous vide cooking process is a type of cooking where a food item (such as meat) is vacuum sealed in a bag and submerged in a bath of water maintained at a desired temperature until the meat reaches the desired internal temperature. Notably, precise temperature control is very desirable for sous vide cooking processes.

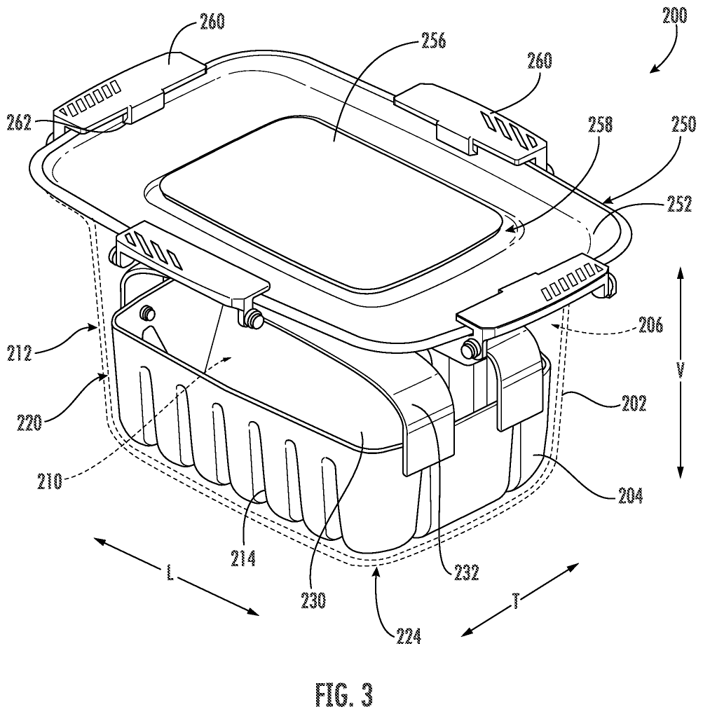

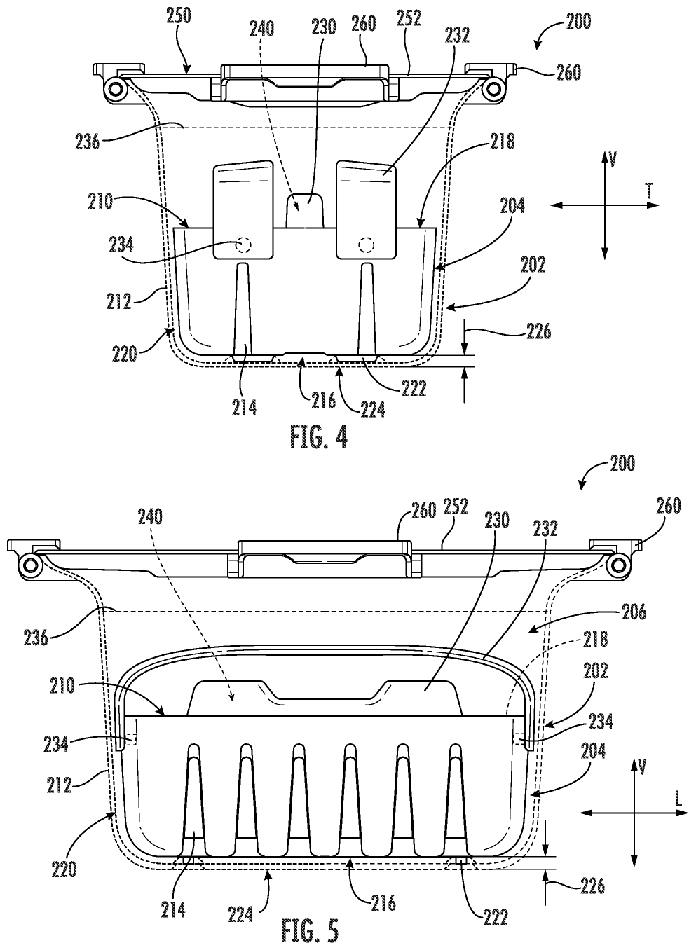

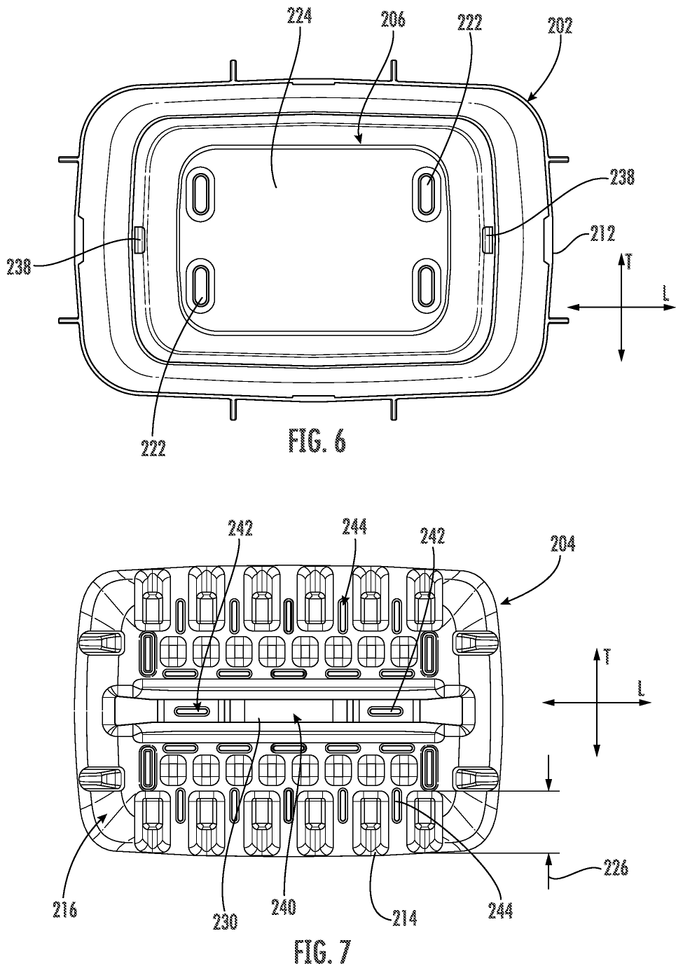

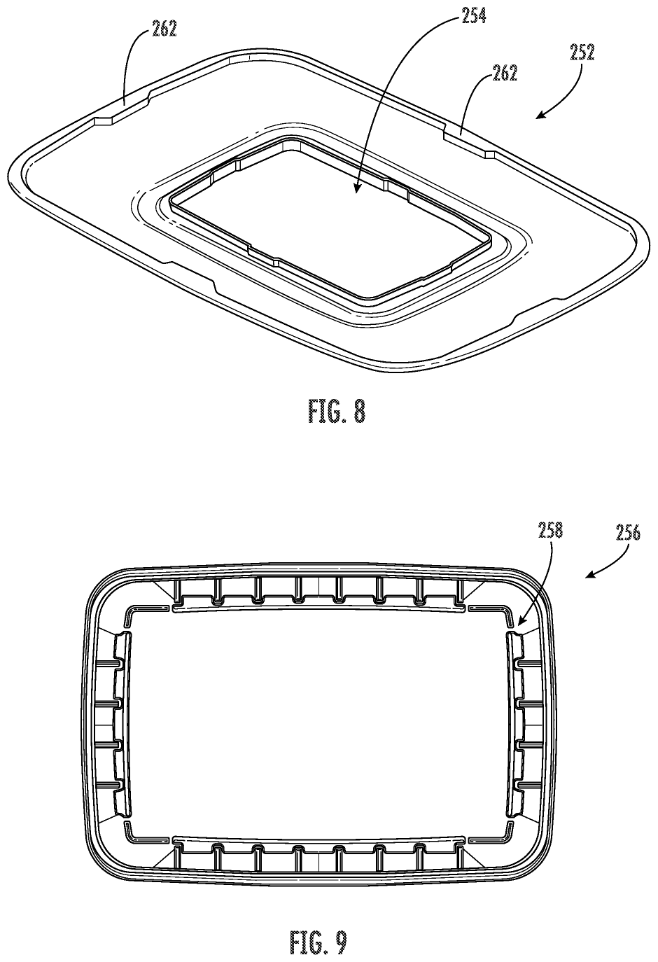

Referring now specifically to FIGS. 3 through 9, a sous vide assembly 200 will be described in detail according to an exemplary embodiment of the present subject matter. As mentioned above, sous vide assembly 200 is generally configured for receipt within cooking chamber 104 microwave oven 100 to facilitate a sous vide cooking process. However, it should be appreciated that the present subject matter is not limited to the specific construction of sous vide assembly 200 or to the particular application described, e.g., use within microwave oven 100.

Referring now to the figures, sous vide assembly 200 generally includes a sous vide container 202 and a food insert 204 positioned inside sous vide container 202. More specifically, sous vide container 202 may define a water reservoir 206 for receipt of food insert 204. In general, sous vide container 202 may be a watertight, open-top container having a bottom wall and a plurality of sidewalls that are joined and configured for containing a volume of liquid (e.g., such as water) to facilitate the sous vide cooking process. Although the sous vide cooking process is described herein as the one with water, it should be appreciated that other suitable cooking foods are possible and within the scope of the present subject matter.

According to the illustrated embodiment, food insert 204 may be positioned within water reservoir 206 and may define one or more food cavities 210 for receiving food items to facilitate a sous vide cooking process. More specifically, according to the illustrated embodiment, an outer wall 212 of food insert 204 may define a plurality of recessed grooves 214 designed to separate or space apart the one or more cavities 210 from the sous vide container 202. Specifically, according to the illustrated embodiment, recessed grooves 214 extend along the vertical direction V from a bottom 216 of food insert 204 upward toward a top 218 of food insert 204. According to the illustrated embodiment, food insert 204 defines two food cavities 210, though food insert 204 may define fewer or more food cavities 210 according to alternative embodiments.

In addition, recessed grooves 214 may be defined by solid walls (e.g., with no aperture is defined therethrough) of food insert 204. In this manner, recessed grooves 214 may retain heated water for uniform heating of food cavities 210. Recessed grooves 214 may also serve to form a heating gap 220. In general, heating gap 220 is a space defined between food cavities 210 and sous vide container 202, e.g., a space within which microwaves that are used to heat water within water reservoir 206 may be absorbed without directly impacting food items being cooked. In this regard, according to the illustrated embodiment, sous vide container 202 and food insert 204 are joined together such that heating gap 220 is maintained throughout the sous vide cooking process. According to still other example embodiments, recessed grooves 214 may be replace by one or more ribs defined on outer wall 212, similar add on feature may be used to separate the food, or an inner container may be mounted inside sous vide container 202 with locators to create a space.

In general, recessed grooves 214 or the alternate constructions described herein may serve to provide space between sous vide container 202 and food cavities 210, e.g., so that the microwave energy does not directly interact with the food stored in the food cavities. In addition, these recessed grooves 214 may act as heat traps. It should be appreciated that other constructions may achieve the same performance enhancements while remaining within the scope of the present subject matter, e.g., such as ribs or protrusions extending from food insert 204 or from sous vide container 202 to create similar separation and/or gaps.

Sous vide assembly 200 may include additional features to maintain heating gap 220 around the bottom and top sides of insert 204 as well. For example, according to the illustrated embodiment, sous vide assembly 200 may include a plurality of tank spacers or standoffs 222 that are positioned between food insert 204 and sous vide container 202 to maintain heating gap 220. According to the illustrated embodiment, standoffs 222 are defined on a bottom wall 224 of sous vide container 202. However, it should be appreciated that according to alternative embodiments, standoffs 222 may alternatively extend from bottom 216 of food insert 204.

According to the illustrated embodiment, heating gap 220 is substantially constant around the sides and along the bottom of food insert 204. However, it should be appreciated that heating gap 220 may vary according to alternative embodiments while remaining within the scope present subject matter. In this regard, for example, heating gap 220 may be larger where microwave energy is more intense, and vice versa. In addition, standoffs 222 and/or heating gap 220 may have any suitable size or dimension. For example, sous vide assembly 200 is generally sized and configured such that microwave energy penetrates the water that is within heating gap 220 while the water and food items (not shown) within food insert 204 are not exposed to direct microwave energy. In this regard, as the microwave energy penetrates water, the electric field intensity decreases exponentially. When heating gap 220 is appropriately sized, substantially all of the microwave energy is absorbed within heating gap 220 (e.g., such that there is negligible cooking effect of the microwave energy on the food items).

Accordingly, heating gap 220 may generally define a gap length 226 that is measured between sous vide container 202 and food cavities 210 of food insert 204. For example, on the sides of food insert 204, gap length 226 may be defined by a groove depth of recessed grooves 214 and on the bottom gap length 226 may be defined by a height of standoffs 222. In this regard, gap length 226 may be measured perpendicular to sous vide container 202 or as the shortest distance between a given point on sous vide container 202 and the closest point to food cavities 210 of food insert 204. According to exemplary embodiments, gap length 226 may be between about 5 millimeters and 40 millimeters, between about 10 millimeters and 30 millimeters, or about 20 millimeters. It should be appreciated that gap length 226 may vary while remaining within the scope of the present subject matter. For example, the desirable gap length may vary based on the proximity of food items to sous vide container 202, to the intensity of microwave energy, or based on any other suitable factors.

Notably, because microwave energy is intended only to penetrate into heating gap 220, the water within the food insert 204 is heated by heat transfer from water within heating gap 220 into food insert 204. Accordingly, food insert 204 may be maintained at the desirable temperature by controlling the microwave energy that is imparted into heating gap 220 without exposing the water within food insert 204 to direct microwave energy. This provides for a more controlled sous vide cooking process within food insert 204.

To avoid exposure of food items to direct microwave energy, food items are intended to be contained entirely within food insert 204. More specifically, according to the illustrated embodiment, sous vide assembly 200 further includes one or more vertical dividers that are positioned within food insert 204 and that extend substantially along the vertical direction V to define food cavities 210. For example, according to the illustrated embodiment, sous vide assembly 200 includes a single central divider 230 that defines two food cavities 210 (though additional dividers may be used to define additional food cavities 210). According to an example embodiment, a food item (e.g., such as a steak) may be positioned within each of the food cavities 210 during the sous vide cooking process.

In general, central divider 230 is illustrated herein as dividing food insert 204 into two identically-sized compartments. However, it should be appreciated that according to alternative embodiments, any suitable number, size, configuration, and orientation of vertical dividers may be used to form any suitable chamber configuration within food insert 204. In general, food cavities 210 are sized such that one or more food items may be positioned within each respective cavity while providing sufficient space for water to surround food items and circulate within food insert 204 for improved temperature uniformity throughout food insert 204 and even cooking.

In addition, it may be desirable to ensure that food items positioned within food insert 204 remain submerged within water, e.g., to prevent direct exposure of food items to microwave energy. Accordingly, sous vide assembly 200 may further include one or more straps 232 extending from top 218 of food insert 204 for retaining food items within the one or more food cavities 210. For example, straps 232 may be rotatably mounted to sous vide container 202 by a plurality of pivot pins 234. According to the illustrated embodiment, pivot pins 234 are defined on straps 232 and are received within apertures defined on food insert 204, though the orientation of these features may be reversed or altered. Notably, straps 232 may be rotated out of the way to insert food items into food cavities 210 and may be rotated upward to secure the food items.

According to the illustrated embodiment, sous vide container 202 defines a target fill line 236 to which a user should fill sous vide container 202 with water prior to commencing a sous vide cooking process. In addition, sous vide container 202 may define one or more depressions 238 (see FIG. 6) for securing food insert 204 toward a bottom of water reservoir 206. Notably, when food insert 204 is seated below depressions 238, the top of straps 232 is positioned such that heating gap 220 is maintained between the top of straps 232 and the target fill line 236. In this manner, heating gap 220 may be consistent along the top, bottom, and sides of food insert 204 to ensure and even and consistent sous vide cooking process. It should be appreciated that other features may also be used to ensure the food insert 204 is properly submerged, e.g., such as one or more snaps, clips, etc.

Sous vide assembly 200 may include additional features to ensure even temperature distribution within and around food insert 204. For example, central divider 230 may define a central fluid column 240 and one or more apertures 242 proximate a top of central divider 230 to provide fluid communication between central fluid column 240 and water reservoir 206. Similarly, bottom 216 of food insert 204 may define a plurality of apertures 244 for providing fluid communication between the one or more food cavities 210 and water reservoir 206. In this manner, heated water may continuously circulate through central fluid column 240 and food cavities 210 to ensure even temperature distribution. According to example embodiments, central divider 230 may also be used to mount one or more sensors, such as a wireless temperature sensor, etc.

According to the illustrated embodiment, sous vide assembly 200 may further include a lid assembly 250 that is removably mounted to sous vide container 202 over water reservoir 206, e.g., to provide selective access to the plurality of food cavities 210. Specifically, according to the illustrated embodiment, lid assembly 250 includes a container lid 252 that is seated on sous vide container 202 and defines a central opening 254. In addition, a lid cap 256 is positioned over central opening 254. Lid cap 256 may be removably received onto container lid 252, e.g., via a snap-fit mechanism.

According to example embodiments, lid assembly 250 may define one or more vent holes 258 that are hidden to maintain attractive appearance while allowing minimal moisture to vent. This may prevent pressure build-up, excessive evaporation, cavity condensation, and door fogging. According to the illustrated embodiment, vent holes 258 are defined between container lid 252 and lid cap 256, e.g., at the corners thereof. These vent holes 258 may define a tortuous path from water reservoir 206 to an ambient environment. For example, vent holes may wind between internal passageways of container lid 252 and/or lid cap 256 and may not provide direct line of sight into water reservoir 206, thereby permitting moisture evacuation while minimizing spillage.

Sous vide assembly 200 may further include a plurality of clips 260 that are pivotally mounted to sous vide container 202 for selectively engaging lid assembly 250. For example, these clips 260 may be pivotally mounted to sous vide container and may be rotated upward to engage protrusions 262 defined on a top of lid assembly 250. Other methods for securing lid assembly 250 to sous vide container 202 are possible and within the scope of the present subject matter.

According to exemplary embodiments, sous vide container 202, food insert 204, and lid assembly 250 may be formed from any suitable materials and have any suitable construction to improve the sous vide cooking process. For example, according to exemplary embodiments, all of these components may be injection molded with a food-grade polymer material. Alternatively, these features may be formed from glass, food grade plastic, silicone, stainless steel, ceramic, glass, etc. Accordingly, it should be appreciated that various features of sous vide assembly 200 may be formed from any suitably rigid material. For example, according to exemplary embodiments, sous vide container 202, food insert 204, and lid assembly 250 may be formed by injection molding, e.g., using a suitable plastic material, such as injection molding grade Polybutylene Terephthalate (PBT), Nylon 6, high impact polystyrene (HIPS), acrylonitrile butadiene styrene (ABS), or any other suitable blend of polymers. Alternatively, according to the exemplary embodiment, these components may be compression molded, e.g., using sheet molding compound (SMC) thermoset plastic or other thermoplastics. According to still other embodiments, portions of sous vide assembly 200 may be formed from any other suitable rigid material.

As explained herein, aspects of the present subject matter are generally directed to a microwave-compatible, space-efficient transparent sous-vide container. The assembly may include a tightly fitted container lid that minimizes heat loss and prevents inadvertent spills by the consumer. The container lid may incorporate a built-in lid cap with discreet vent holes, effectively preventing pressure build-up, excessive evaporation, cavity condensation, and door fogging-all while maintaining an aesthetically pleasing appearance. A rotating lid latch can also be used to secure the lid to the container, further mitigating the spillage risks. The sous-vide assembly may also consist of an outer container which is equipped with a fill line and an insert retainer, thereby preventing the insert (inner container) from floating when loaded with buoyant food items. The insert may be made up of a soft material and be positioned within the outer container to provide a secure grip on the food items and isolate them from microwave energy. The insert may feature hinge points that accommodate insert straps, thereby preventing food from floating and facilitating easy insertion and removal. This design ensures efficient sous-vide cooking in a microwave, enhancing user convenience and maintaining a sleek visual appeal.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A sous vide assembly for use in a microwave oven, the microwave oven comprising a cabinet defining a cooking chamber, the sous vide assembly comprising:
a sous vide container defining a water reservoir; and
a food insert positioned inside the water reservoir and defining one or more food cavities, wherein the outer walls of the food insert define a plurality of recessed grooves that separate the one or more food cavities from the sous vide container and the plurality of recessed grooves extend along the outer walls and bottom of the food insert and define a groove depth to define a heating gap between the outer walls of the food insert and the sous vide container along a lateral or transverse direction.

2. The sous vide assembly of claim 1, wherein a bottom wall of the sous vide container defines one or more standoffs for supporting the food insert and spacing the food insert away from the sous vide container.

3. The sous vide assembly of claim 1, wherein the food insert further comprises:
a center divider extending along a vertical direction to divide the one or more food cavities into a first food cavity and a second food cavity.

4. The sous vide assembly of claim 3, wherein the center divider defines a central fluid column.

5. The sous vide assembly of claim 4, wherein the center divider defines a plurality of apertures proximate a top of the central divider to provide fluid communication between the central fluid column and the water reservoir.

6. The sous vide assembly of claim 1, wherein the food insert defines more than two food cavities.

7. The sous vide assembly of claim 1, further comprising one or more straps extending from a top of the food insert for retaining food items within the one or more food cavities.

8. The sous vide assembly of claim 7, wherein the one or more straps are rotatably mounted to the food insert by one or more pivot pins per strap.

9. The sous vide assembly of claim 1, wherein the sous vide container defines a target fill line, and wherein an upper heating gap is defined along a vertical direction between the target fill line and the food insert.

10. (canceled)

11. The sous vide assembly of claim 10, wherein the groove depth is between about 10 and 20 millimeters.

12. The sous vide assembly of claim 1, wherein the sous vide container defines one or more depressions, snaps, or clips for securing the food insert toward a bottom of the water reservoir.

13. The sous vide assembly of claim 1, wherein a bottom of the food insert defines a plurality of apertures for providing fluid communication between the one or more food cavities and the water reservoir.

14. The sous vide assembly of claim 1, further comprising:
a lid assembly mounted to a top of the sous vide container, the lid assembly being removable or pivotable to provide selective access to the one or more food cavities, wherein the lid assembly defines one or more vent holes.

15. The sous vide assembly of claim 14, wherein the lid assembly comprises:
a container lid that is seated on the sous vide container and defines a central opening; and
a lid cap that is positioned over the central opening, the one or more vent holes being defined between the container lid and the lid cap.

16. The sous vide assembly of claim 15, wherein the one or more vent holes define a tortuous path from the water reservoir to an ambient environment.

17. The sous vide assembly of claim 14, further comprising:
a plurality of clips that are pivotally mounted to the sous vide container for selectively engaging the lid assembly.

18. The sous vide assembly of claim 1, wherein the sous vide container is formed from glass or food grade plastic.

19. The sous vide assembly of claim 1, wherein the food insert is made of food grade plastic, silicone, stainless steel, ceramic, or glass.

20. A microwave oven defining a vertical, a lateral, and a transverse direction, the microwave oven comprising:
a cabinet defining a cooking chamber;
a door rotatably mounted to the cabinet for providing selective access to the cooking chamber; and
a sous vide assembly configured for receipt within the cooking chamber, the sous vide assembly comprising:
a sous vide container defining a water reservoir;
a food insert positioned inside the water reservoir and defining one or more food cavities, wherein the outer walls of the food insert define a plurality of recessed grooves that separate the one or more food cavities from the sous vide container and the plurality of recessed grooves extend along the outer walls and bottom of the food insert and define a groove depth to define a heating gap between the outer walls of the food insert and the sous vide container along a lateral or transverse direction; and
a lid assembly mounted to a top of the sous vide container, the lid assembly defining one or more vent holes and being removable to provide selective access to the one or more food cavities.

21. The microwave oven of claim 20, wherein a bottom of the food insert defines a plurality of apertures for providing fluid communication between the one or more food cavities and the water reservoir.
